(19) United States
(12) Patent Application Publication
(10) Pub. No.: US 2005/0041001 A1
(43) Pub. Date: Feb. 24, 2005

(54) Plasma display panel and manufacturing method

(76) Inventors: Keisuke ` Sumida, Osaka (JP); Hiroyuki Yonehara, Osaka (JP); Morio Fujitani, Osaka (JP); Hideki Asida, Osaka (JP)

Correspondence Address: McDermott Will & Emery, 600 13th Street NW, Washington, DC, 20005-3096, US

(21) Appl. No.: 10/478,956

(22) PCT Filed: May 28, 2001
(86) PCT No.: PCT/JP02/05101

(30) Foreign Application Priority Data
May 28, 2001 (JP) 2001-158726

(51) Int. Cl. G09G 3/28

(52) U.S. Cl. 345/60

(57) ABSTRACT

A plasma display panel includes a first panel member in which a plurality of pairs of display electrodes are arranged so as to be adjacent to each other in a column direction and a second panel member in which a plurality of address electrodes are arranged so as to be adjacent to each other in a row direction, and the first panel member and the second panel member are opposed to each other so that a plurality of cells are formed in a matrix in areas where the plurality of pairs of display electrodes intersect with the plurality of address electrodes. The plasma display panel is characterized in that at least one of an average cell area, an average cell opening ratio and an average visible light transmittance efficiency is greater in a panel central region than in a panel peripheral region.

### TECHNICAL FIELD

The present invention relates to a plasma display panel and a manufacturing method thereof, and more specifically, to a technique for improving the panel visibility without causing an increase in power consumption.

### BACKGROUND ART

A plasma display panel (hereinafter referred to as PDP) is one type of gas discharge panel. PDPs are a self-luminous display panel in which image display is achieved in such a manner that phosphors are excited by ultraviolet rays that are generated by a gas discharge so as to emit light. PDPs are classified into alternating current (AC) types and direct current (DC) types, according to their discharge methods. AC types are better than DC types in terms of luminance, luminous efficiency, and lifetime. Among AC types, a reflective surface discharge type excels particularly in luminance and luminous efficiency, and therefore, is the most common type. There is an increasing social demand for AC-type PDPs to be used as a display screen on computers, large televisions, and the like.

Nowadays, electronic products that provide as low power consumption as possible are desired. Accordingly, it is desired to reduce power consumed when driving PDPs. Because of the recent tendency for a PDP with a larger screen and higher definition, power consumption of PDPs that have lately been developed is on the rise. Therefore, there is a high demand for techniques of saving power consumed in PDPs. Also, it is generally desired that PDPs deliver stable image-display performance.

In conclusion, there is a demand for a PDP that achieves superior display performance as well as low power consumption at present.

### DISCLOSURE OF THE INVENTION

The present invention was made in view of the above-mentioned problems. It is an object of the present invention to provide a PDP that achieves excellent display performance without causing an increase in power consumption and a manufacturing method for the same.

The inventors of the present invention devoted themselves to solve the above problems. As a result, they invented a PDP including a first panel member in which a plurality of pairs of display electrodes are arranged so as to be adjacent to each other in a column direction and a second panel member in which a plurality of address electrodes are arranged so as to be adjacent to each other in a row direction, the first panel member and the second panel member being opposed to each other so that a plurality of cells are formed in a matrix in areas where the plurality of pairs of display electrodes intersect with the plurality of address electrodes, characterized in that at least one of an average cell area, an average cell opening ratio and an average visible light transmittance efficiency is greater in a panel central region than in a panel peripheral region.

To be more specific, this is realized in the following manner. A distance between adjacent pairs of display electrodes is larger in a central region than in both edge regions of the panel in the column direction. Note that each of the regions is later defined by concrete numerical values in the description of the embodiments.

Generally speaking, display information tends to concentrate in a panel central region when displaying, for example, moving images on a display screen. In addition, the gaze of people watching the display screen tends to concentrate in the panel central region in both the lengthwise and crosswise directions of a panel. In addition, if there are two PDPs that achieve the same level of luminance in the panel central region in which the gaze tends to concentrate, higher visibility is achieved in the PDP which provides lower luminance in the panel peripheral region surrounding the panel central region than the other.

The present invention is based on the above tendency. With the above construction, at least one of the average cell area, the average cell opening ratio, and the average visible light transmittance efficiency is made relatively greater in the panel central region. In this way, relatively higher luminance is achieved in a cell group corresponding to the panel central region than in a cell group corresponding to the panel peripheral region. Accordingly, in the PDP of the present invention, luminance in the cell group corresponding to the panel central region in which the gaze of people concentrates is effectively improved. Therefore, excellent visibility is achieved, and superior display performance is attained.

Here, at least one of the average cell area, the average cell opening ratio and the average visible light transmittance efficiency is locally increased as described above. However, display electrodes and address electrodes similar to those in the related art can be used for the PDP of the present invention. Accordingly, the effects of the present invention can be attained without a particular increase in power consumption.

Here, a gap between electrodes in a pair of display electrodes in a central region of the panel in the column direction may be larger than a gap between electrodes in a pair of display electrodes in each edge region of the panel in the column direction.

With this construction, the cell area and the visible light transmittance efficiency are the same across the entire PDP. However, the distances between display electrodes in each pair, that is, a main discharge gap, are made larger in the panel central region. In this way, relatively higher luminance is achieved in the panel central region, and almost the same result as the construction mentioned before is obtained.

As an alternative, a distance between adjacent address electrodes may be larger in a central region than in both edge regions of the panel in the row direction. In addition, a distance between adjacent pairs of display electrodes may be larger in a central region than in both edge regions of the panel in the column direction, and a distance between adjacent address electrodes may be larger in a central region than in both edge regions of the panel in the row direction.

Here, a bus line of a display electrode may increase in width from a center towards both ends of the display electrode in a lengthwise direction.

With this construction, a bus line of a display electrode is made narrowest in the panel central region to increase a scale of discharge, and the bus line increases in area towards both edge regions of the panel. As a result, the cell opening ratio is made higher in the panel central region, achieving almost the same effect as the construction mentioned before.

Here, each display electrode may be composed of a set of metal line members that are electrically connected together, and a width of a set of metal line members in a central region of the panel in the column direction may be smaller than a width of a set of metal line members in each edge region of the panel in the column direction.

With this construction, the cell opening ratio can be also changed by adjusting the total widths of the sets of line members, achieving almost the same result as the construction mentioned before.

Here, black films may be formed on the first panel member between adjacent pairs of display electrodes, and black films in a central region of the panel in the column direction may be narrower than black films in each edge region of the panel in the column direction.

With this construction, the cell opening ratio can be also changed by adjusting the widths of the black matrixes, achieving almost the same effect as the construction mentioned before.

Here, barrier ribs may be disposed between the first panel member and the second panel member so as to alternate with the plurality of address electrodes, and barrier ribs in a central region of the panel in the row direction may be narrower than barrier ribs in each edge regions of the panel in the row direction.

With this construction, the cell opening ratio can be changed by adjusting the widths of the barrier ribs, achieving almost the same result as the construction mentioned before.

Here, auxiliary barrier ribs may be formed between the first panel member and the second panel member so as to alternate with the plurality of pairs of display electrodes, and auxiliary barrier ribs in a central region of the panel in the column direction may be narrower than auxiliary barrier ribs in each edge regions of the panel in the column direction.

With this construction, the cell opening ratio can be also changed by adjusting the widths of the auxiliary barrier ribs, achieving almost the same result as the construction described before.

Here, the display electrode, the black matrix, the barrier rib, and the auxiliary barrier rib may increase in area from a center to both edges thereof in the lengthwise direction.

### BRIEF DESCRIPTION OF THE DRAWINGS

FIG. 1 is a cross-sectional perspective view showing part of a PDP.

FIG. 2 is a schematic view presenting a cell arrangement of the PDP.

FIG. 3 is a schematic view presenting a cell arrangement of a PDP relating to a first embodiment.

FIG. 4 is a schematic view presenting a cell arrangement of a PDP relating to a modification of the first embodiment.

FIG. 5 is a schematic view presenting a cell arrangement of a PDP relating to a modification of the first embodiment.

FIG. 6 is a schematic view presenting an arrangement of display electrodes in a display region of a PDP.

FIG. 7 is a schematic view presenting an arrangement of display electrodes relating to a second embodiment.

FIG. 8 is a schematic view presenting configurations of display electrodes relating to a modification of the second embodiment.

FIG. 9 is a schematic view presenting configurations of display electrodes relating to a modification of the second embodiment.

FIG. 10 is a schematic view presenting configurations of display electrodes relating to a third embodiment.

FIG. 11 is a schematic view presenting configurations of display electrodes relating to a modification of the third embodiment.

FIG. 12 is a schematic view presenting configurations of display electrodes relating to a fourth embodiment.

FIG. 13 is a schematic view presenting configurations of black films applied between adjacent display electrodes in a fifth embodiment.

FIG. 14 is a schematic view presenting configurations of black films applied between adjacent display electrodes in a modification of the fifth embodiment.

FIG. 15 is a schematic view presenting configurations of black films applied between adjacent display electrodes in a modification of the fifth embodiment.

FIG. 16 is a schematic view presenting configurations of barrier ribs relating to a sixth embodiment.

FIG. 17 is a schematic view presenting configurations of auxiliary barrier ribs relating to a modification of the sixth embodiment.

FIG. 18A and FIG. 18B are cross-sectional views presenting a configuration of a dielectric layer relating to a seventh embodiment.

FIG. 19 presents a configuration of a mask used for patterning display electrodes.

FIG. 20 presents a configuration of a mask used for patterning display electrodes.

FIG. 21 shows steps of an exposure process.

FIG. 22 is a conceptual view presenting the exposure process performed using a concave lens.

FIG. 23 presents a procedure for manufacturing a dielectric layer.

### BEST MODE FOR CARRYING OUT THE INVENTION

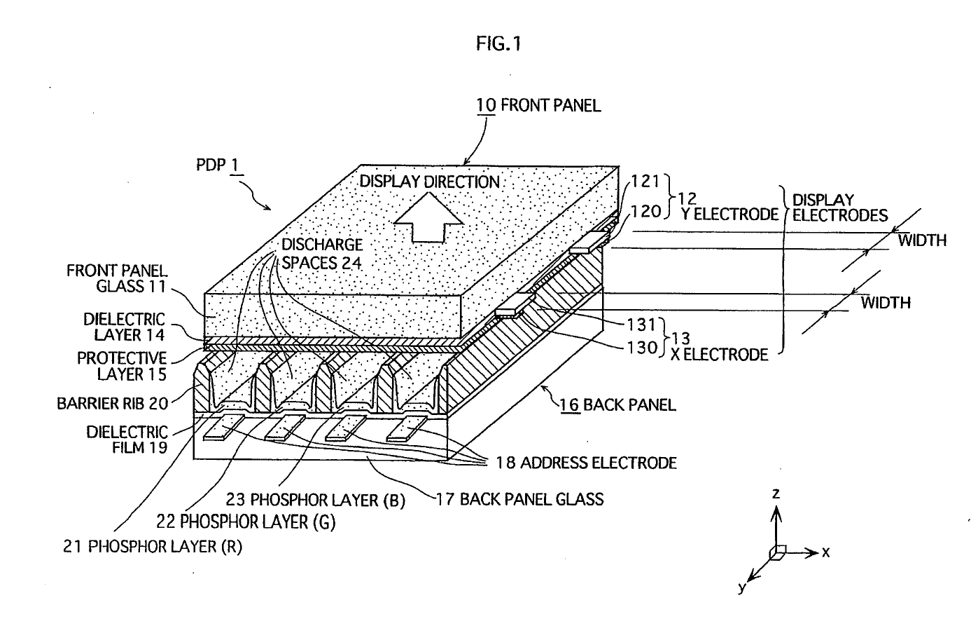

FIG. 1 is a fragmentary perspective view showing a construction of an AC type PDP 1 of the present invention. In the PDP 1, a number of discharge cells each of which emits light of one of red (R), green (G), and blue (B) are arranged in turn.

A plurality of transparent electrodes 121 and 131 are formed in stripes so as to extend in the x direction, on a front panel glass 11 composed of soda-lime glass or the like. The transparent electrodes 121 and 131 are strip electrodes, and formed using indium tin oxide (ITO) or SnO₂. Since the transparent electrodes 121 and 131 have high sheet resistance, bus electrodes 120 and 130 are provided on the transparent electrodes 121 and 131 respectively. The bus electrodes 120 and 130 are made of a silver (Ag) thick film, an aluminum (Al) thin film, a chrome-copper-chrome laminated thin film, or the like, so as to reduce the sheet resistance. With this configuration, a plurality of pairs of display electrode 12 (a sustain electrode 12, that is, a Y electrode 12) and display electrode 13 (a scan electrode 13, that is, an X electrode 13) are provided so as to be adjacent to each other in the column direction (the y direction) of the panel.

A dielectric layer 14 composed of transparent glass with a low softening point and a protective layer 15 composed of magnesium oxide (MgO) are formed in this order on the front panel glass 11 on which the display electrodes 12 and 13 are formed. The dielectric layer 14 has a function of limiting electric currents. This function is peculiar to AC type PDPs, and enables AC type PDPS to have a longer lifetime than DC types. The protective layer 15 has a function of protecting the dielectric layer 14 from being scraped off when the dielectric layer 14 is sputtered during a discharge. The protective layer 15 has a high ability to withstand sputtering, a high secondary electron emission coefficient (γ), and a function of lowering a discharge firing voltage.

A plurality of address electrodes 18 (data electrodes 18; DAT) used for writing image data are provided on a back panel glass 17 so as to cross over the display electrodes 12 and 13 at right angles. The address electrodes 18 extend in the y direction, and are adjacent to each other in the x direction. An undercoat dielectric film 19 is formed on the back panel glass 17 so as to cover the address electrode 18. A plurality of barrier ribs 20 are formed on the surface of the dielectric film 19 in correspondence with the address electrodes 18. One of a phosphor layer 21 (R), a phosphor layer 22 (G), and a phosphor layer 23 (B) is formed between adjacent barrier ribs 20.

Spaces between adjacent barrier ribs 20 are discharge spaces 24. A gas mixture of neon (Ne) and xenon (Xe) is enclosed in the discharge spaces 24 as a discharge gas at a pressure of around 66.5 kPa (500 Torr). The barrier ribs 20 serve to partition adjacent discharge cells, thereby preventing an erroneous discharge and optical crosstalk.

A black matrix (black film), an auxiliary barrier rib or the like may be formed between two adjacent pairs of display electrodes 12 and 13.

An AC voltage of from several dozen kHz to several hundred kHz is applied between display electrodes 12 and 13 in each pair, causing a discharge to occur in the discharge spaces 24. This excites xenon atoms, which emit ultraviolet rays. The phosphor layers 21 (R), 22 (G), 23 (B) are excited by the ultraviolet rays, to emit visible light. In this way, an image is displayed.

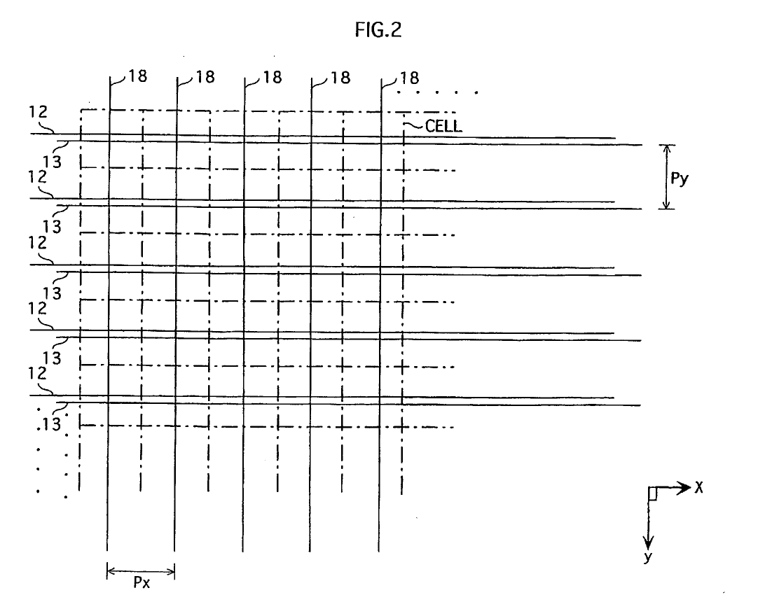

FIG. 2 is a top view showing part of a front panel 10. As shown in FIG. 2, a plurality of cells are arranged in a matrix configuration in areas where the pairs of display electrodes 12 and 13 intersect at right angles with the address electrodes 18 with the discharge spaces 24 therebetween.

A PDP relating to each of the following embodiments is primarily characterized by a configuration around the display electrodes 12 and 13. Each embodiment is described with a main focus on its characteristics.

First Embodiment

[1.1 Construction of a PDP]

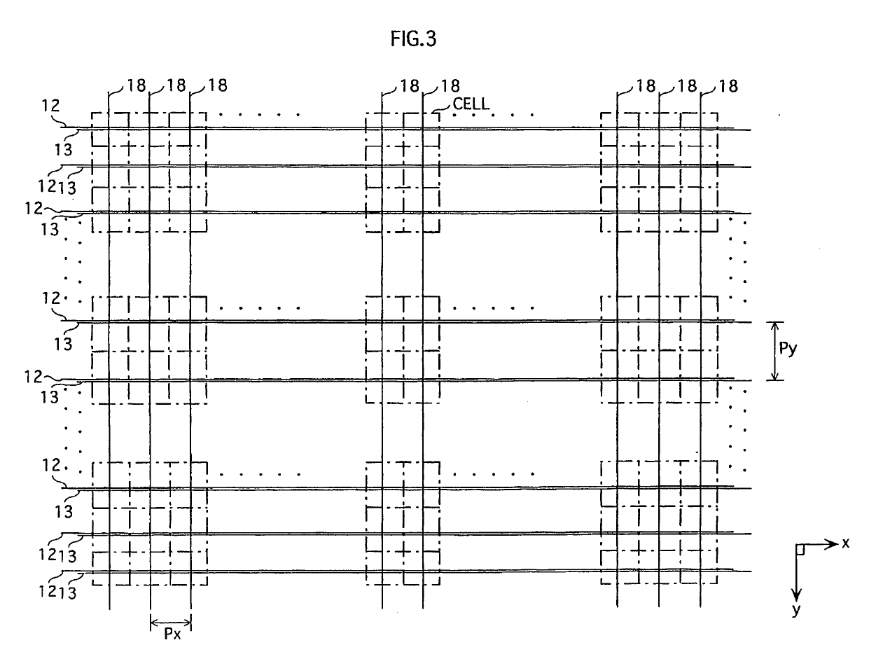

FIG. 3 is a schematic view showing an arrangement of the display electrodes 12 and 13 and the address electrodes 18 in the PDP 1 relating to a first embodiment. Here, FIG. 3 is a plan view showing a plane parallel to the xy plane in FIG. 1. In FIG. 3, Pₓ indicates a pitch of the address electrodes 18 that are arranged so as to be adjacent to each other in the horizontal (x) direction of the panel. P_{y} indicates a pitch of the display electrodes 12 or 13 that are arranged so as to be adjacent to each other in the vertical (y) direction of the panel. P_{y} is hereinafter referred to as a display electrode pitch. The display electrodes 12 and 13 have a laminated construction including a transparent electrode and a bus line as described before, but they are schematically indicated by straight lines in FIG. 3.

In all of the following embodiments, the x direction and the y direction represent the row direction and the column direction respectively.

As shown in FIG. 3, each of a plurality of cells corresponds to each of a plurality of pairs of the display electrodes 12 and 13 in the PDP 1 relating to the first embodiment. Here, the cells are arranged in a matrix configuration in such a manner that the cell area gradually decreases from a panel central region towards the top and bottom edges of the panel (each edge of the panel in the vertical direction). In detail, this is achieved by gradually decreasing the pitch P_{y} of the display electrodes that are adjacent to each other in the y direction from the panel central region towards the top and bottom edges of the panel. When the display electrode pitch P_{y} is smaller, the cell area is smaller. This is because a distance between adjacent cells (that is, a distance between adjacent sustain electrodes) decreases as the display electrode pitch decreases.

In this way, an average cell area is set larger in the panel central region than in a panel peripheral region which surrounds the panel central region in the PDP 1.

Here, the panel central region is a region whose center corresponds to the intersection point of the diagonal lines of the rectangular front panel glass 11 and whose shorter and longer sides are within 90% to 95% of the shorter and longer sides of the front panel glass 11. The panel peripheral region is a panel region surrounding the panel central region. Also, the average cell area is a numerical value obtained by calculating an average of the areas of a plurality of cells belonging to each region. According to this definition, the area of the panel central region is equal to 60% to 70% of the total area of all of the cells.

The dimensions of the various parts of the above PDP 1 are, for example, as follows.

The gap between one display electrode 12 and one display electrode 13 forming one pair: 90 μm

Pₓ: 360 μm

P_{y} in the panel central region: 1080 μm

P_{y} at the top and bottom edges of the panel: 810 μm

The width of one transparent electrode: 100 μm

The width of one bus line: 40 μm

In the PDP 1 of this construction, in the panel central region where the display electrodes 12 and 13 are arranged with large pitch P_{y}, the cell area is large. This ensures high luminance. On the other hand, in the top and bottom regions of the panel where the display electrodes 12 and 13 are arranged with small pitch P_{y}, the cell area is small. This produces relatively low luminance. Note that the ratio of the cell size of the largest cell to that of the smallest cell is approximately 1:0.75, if the ratio between the cell pitches is 1080 μm:810 μm as stated above. Thus, the difference in cell size is very small. Accordingly, images displayed on the panel will not be distorted, and the panel size will not differ substantially from image size specifications.

Generally speaking, when displaying an image such as a moving image on a display screen, image data of the image tends to concentrate in the panel central region. Also, a viewer tends to focus on the panel central region.

The PDP 1 relating to the first embodiment is developed taking this tendency into consideration. In detail, high luminance is achieved in the cells included in the panel central region (that is, a cell group corresponding to the display electrodes 12 and 13 arranged in the panel central region). On the other hand, luminance is limited to a low level in small cells included in the panel peripheral region (that is, a cell group corresponding to the display electrodes 12 and 13 arranged at both edges of the panel in the y direction). In this way, the average cell area is made relatively greater in the panel central region than in the panel peripheral region. This limits the power consumption of the whole PDP 1 to a conventional level, and, at the same time, realizes excellent display performance based on superior visibility, by securing high luminance in the panel region on which a viewer focuses. Here, the average cell area may be made absolutely large and small in the panel central region and the panel peripheral region respectively. However, it needs to be considered that the power consumption of the whole panel should not increase, especially if the cell area is made larger than in the related art.

Here, the PDP 1 can be driven with power consumption of a conventional level, and, at the same time, demonstrates excellent visibility, if the same display and address electrodes as in the related art are used for the display electrodes 12 and 13 and the address electrodes 18 that correspond to the cells. As a result, excellent luminous efficiency is achieved.

In the first embodiment, P_{y} is gradually decreased from the panel central region towards the top and bottom edges of the panel, but the invention is not limited to such. As an alternative, P_{y} may be decreased step by step in several to several dozen phases. This, however, should be done so as not to cause image distortion due to the differences in cell size when displaying an image (the distortion should not be visible for the human eyes).

[1.2 Modification of the First Embodiment]

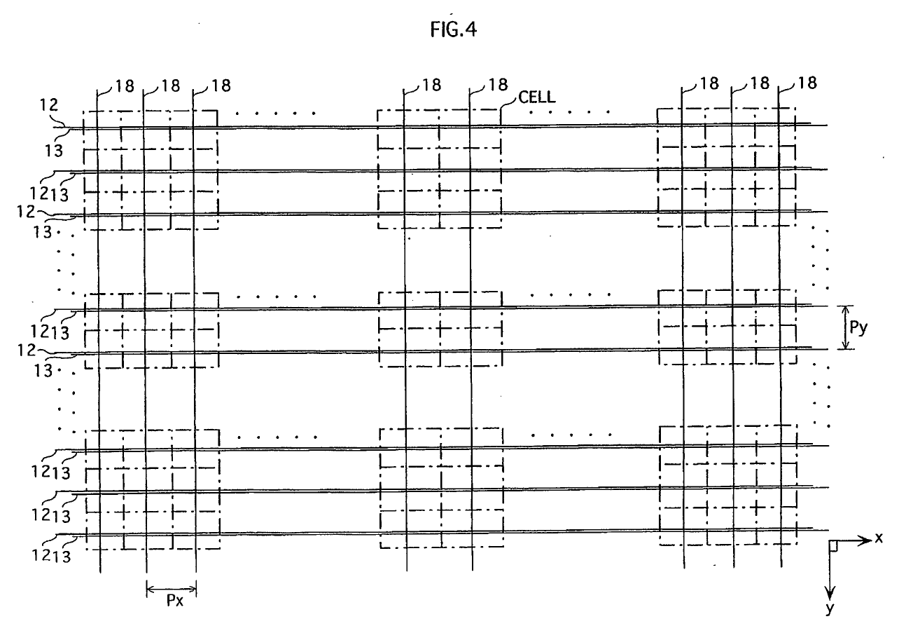

In the first embodiment described above, the display electrode pitch P_{y} is made large in the panel central region, so that the cell area of the cells corresponding to the display electrodes 12 and 13 arranged in the panel central region is relatively large. The present invention is, however, not limited to such. For example, as shown in a modification 1-1 of FIG. 4, the pitch Pₓ of the address electrodes 18 may be gradually decreased (e.g. from 360 μm to 270 μm) from the panel central region towards each edge of the panel in the horizontal (x) direction. In this way, the cell area of the cell group corresponding to the address electrodes 18 arranged in the panel central region is made large, and the cell area of the cell group corresponding to the rest of the address electrodes 18 is made small. According to this alternative construction too, the average cell area can be made larger in the panel central region than in the panel peripheral region. As a result, effects similar to the above first embodiment are obtained.

The number of address electrodes is normally larger than the number of pairs of display electrodes. Accordingly, if the pitch of the address electrodes 18 is adjusted in the above way, the cell area changes from the panel central region towards the left and right edges of the panel with such a small rate that the changes in cell width are hardly visible to human eyes, especially in PDPs having large widths, such as high-definition PDPs. As a result, visibility in the panel central region is effectively improved.

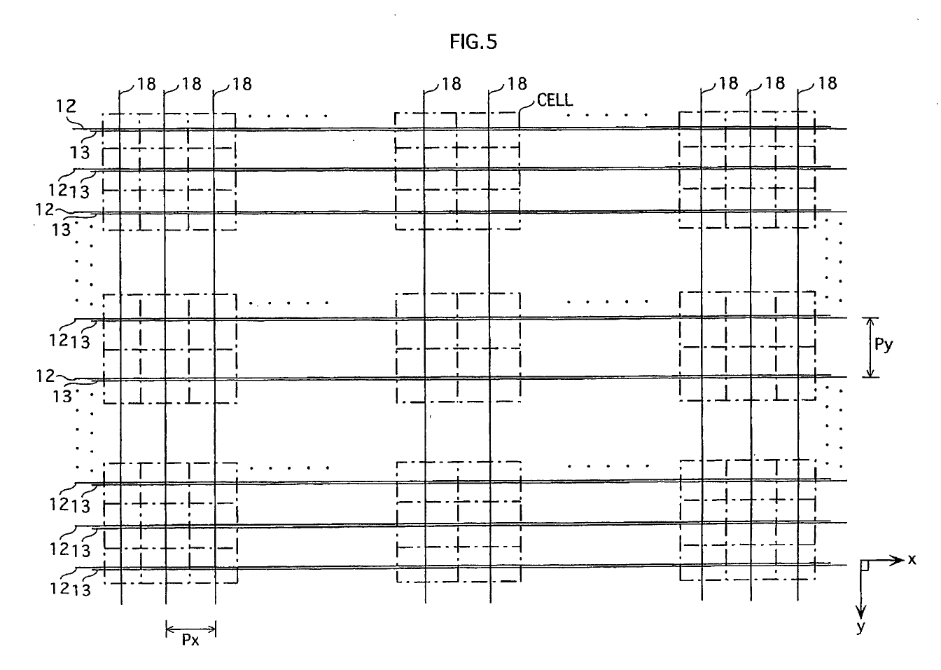

Also, the first embodiment and the modification 1-1 described above may be combined as a modification 1-2 shown in FIG. 5. In FIG. 5, both the display electrode pitch P_{y} and the pitch Pₓ of the address electrodes 18 are adjusted so that the cell area of the cells in the panel central region is made large and the cell area of the cells in the panel peripheral region is made small. According to this construction too, the average cell area is made larger in the panel central region than in the panel peripheral region. Since synergetic effects of the first embodiment and the modification 1-1 are produced with this construction, a PDP 1 having excellent display performance can be achieved.

[1.3 Manufacturing Method of the PDP]

The following part describes one example of a manufacturing method of the PDP 1 relating to the first embodiment. The manufacturing method to be described here is largely the same as that of a PDP 1 relating to each of the other embodiments.

[1.3.1. Manufacturing the Front Panel 10]

The display electrodes 12 and 13 are formed on the surface of the front panel glass 11 which is a soda-lime glass having a thickness of around 2.6 mm. Here, an example method (a thick-film forming method) of forming the display electrodes 12 and 13 as a metal electrode using a metal material (Ag) is explained.

A metal (Ag) powder and an organic vehicle are mixed with a photosensitive material (photodegradable resin), to form a photosensitive paste. This is applied on one main surface of the front panel glass 11, and then covered with an exposure mask having a pattern of the display electrodes 12 and 13 to be formed. Next, the photosensitive paste is exposed to light through the exposure mask, and the result is developed and fired (at a firing temperature of around 590° C. to 600° C.). Here, when compared with a screen-printing method that only enables a line width of 100 μm at the narrowest, this method enables a line width of as narrow as around 30 μm to be achieved. It should be noted that platinum (Pt), gold (Au), aluminum (Al), nickel (Ni), chrome (Cr), tin oxide, indium oxide, or the like may be also used for the above-mentioned metal material. The amount of photosensitive paste applied is adjusted so as that the electrodes are 2 μm to 5 μm in thickness.

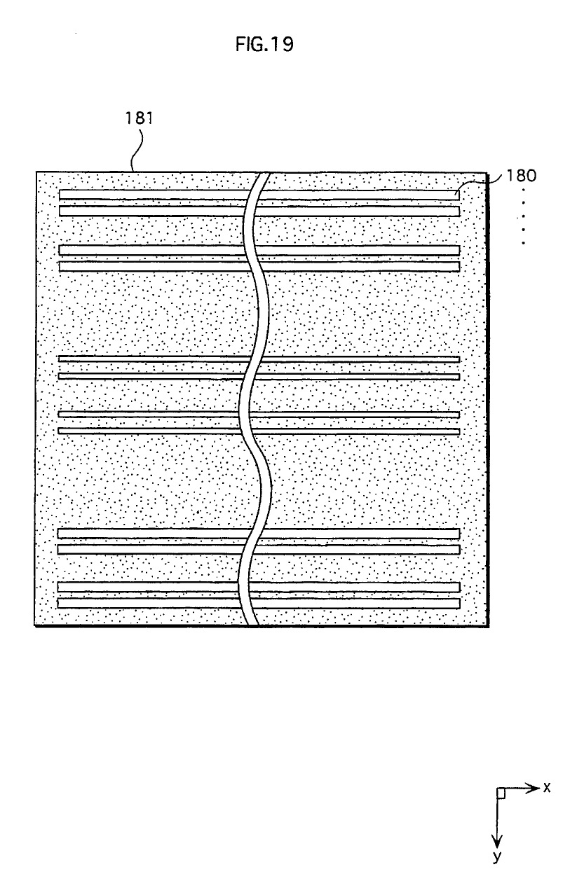

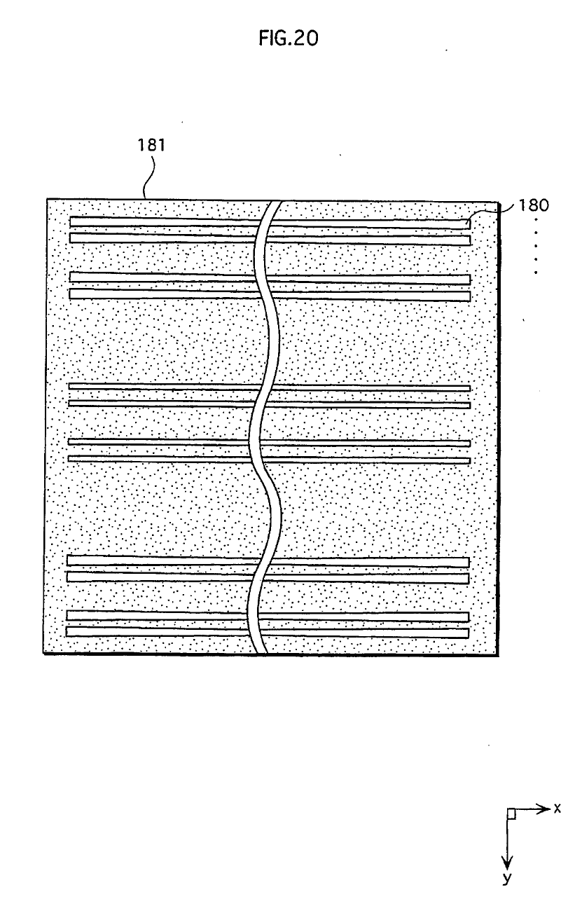

In addition, a method of forming the display electrodes 12 and 13 including the transparent electrodes 120 and 130 and the bus lines (metal electrodes) 121 and 131 is as follows. A photosensitive material (e.g. ultraviolet-cure resin) is first applied at a thickness of 0.5 μm on the entire surface of the front panel glass 11. Next, the photosensitive material is covered with an exposure mask having a desired pattern, and then irradiated with ultraviolet rays. The result is then soaked is into a developer in order to wash off uncured resin. Here, by using an exposure mask created by clipping out a predetermined pattern as shown in FIG. 19 and FIG. 20, an electrode pattern can be suitably varied. Following this, ITO is applied to the gaps in the photosensitive material on the front panel glass 11 using a chemical vapor deposition (CVD) method, as a material of the transparent electrodes 120 and 130. The result is fired to obtain the transparent electrodes 120 and 130 of 10 μm to 150 μm in width and 2 μm to 5 μm in thickness.

The bus lines (metal electrodes) 121 and 131 are formed on the transparent electrodes 120 and 130 using an exposure mask as described above.

In addition to the methods described above, the display electrodes 12 and 13 may be formed by the following manner. An electrode material is formed into a film using a vapor deposition method, a sputtering method or the like, and the result is processed using an etching method.

After the display electrodes 12 and 13 are formed, a glass paste is applied using a printing method or the like, and the result is fired to form the dielectric layer 14.

Following this, the protective layer 15 having a thickness of around 0.3 μm to 0.6 μm is formed on the surface of the dielectric layer 14 using a vapor deposition method, a CVD method or the like. Magnesium oxide (MgO) is suitable for the protective layer 15.

This completes the front panel.

[1.3.2. Manufacturing a Back Panel 16]

The back panel glass 17 is a soda-lime glass of approximately 2.6 mm in thickness. The address electrodes 18 having a thickness of around 5 μm are formed on the surface of the back panel glass 17 by applying a conductive material mainly composed of Ag in stripes. The address electrodes 18 may be formed using a screen-printing method, a photoetching method or the like.

Following this, a lead glass paste is applied at a thickness of 20 μm to 50 μm on the entire surface of the back panel glass 17 on which the address electrodes 18 have been formed, and the result is fired to form the dielectric film 19.

After this, a lead glass material which is the same as the one used for the dielectric film 19 is used for forming the barrier ribs 20 on the dielectric film 19. The barrier ribs 20 have a height of 80 μm to 150 μm, and are formed between adjacent address electrodes 18. The barrier ribs 20 are formed, for example, by repeatedly applying a paste including the above-mentioned glass material using screen printing and firing the result.

As an alternative, the address electrodes 18 and the barrier ribs 20 may be formed using a photoetching method, which is described above as a method for forming the display electrodes 12 and 13.

After forming the barrier ribs 20, a phosphor ink including one of a red (R) phosphor, a green (G) phosphor and a blue (B) phosphor is applied onto the wall surfaces of the barrier ribs 20 and part of the surface of the dielectric film 19 between the barrier ribs 20. Then, the result is dried and fired to form the phosphor layers 21, 22, and 23 each of which has a thickness of from 10 μm to 40 μm.

One example of a phosphor material for each color that is generally used in PDPs is presented in the following.

Red phosphor: (YₓGd₁₋ₓ) BO₃:Eu³⁺

Green phosphor: Zn₂SiO₄:Mn³⁺

Blue phosphor: BaMgAl₁₀Oₗ₇:Eu³⁺ (or BaMgAl₁₄O₂₃:Eu³⁺)

As an example, a powder having an average particle size of around 3 μm can be used for each of the phosphor materials. There are several methods for applying the phosphor ink. Here, a well known meniscus method is employed. According to the meniscus method, the phosphor ink is sprayed from a very narrow nozzle so as to form a meniscus (a bridge caused by a surface tension). This method is suitable for uniformly applying the phosphor ink to a target region. Needless to say, the present invention is not limited to such a method, and other methods such as a screen-printing method can also be used.

This completes the back panel 16.

In this example, the front panel glass 11 and the back panel glass 17 are formed from soda-lime glass. However, soda-lime glass is only given as an example material, and can be replaced with other material.

[1.3.3. Completing the PDP]

The front panel 10 and the back panel 16 are sealed together using sealing glass. After this, the air is evacuated from the discharge spaces 24 to form a high vacuum (around 1.1×10⁻⁴ Pa), and a discharge gas, such as a Ne—Xe gas mixture, a He—Ne—Xe gas mixture, a He—Ne—Xe—Ar gas mixture or the like, is enclosed into the discharge spaces 24 at a predetermined pressure (66.5 kPa in this embodiment).

Here, the PDP 1 is completed.

Second Embodiment

[2.1. Construction of the PDP]

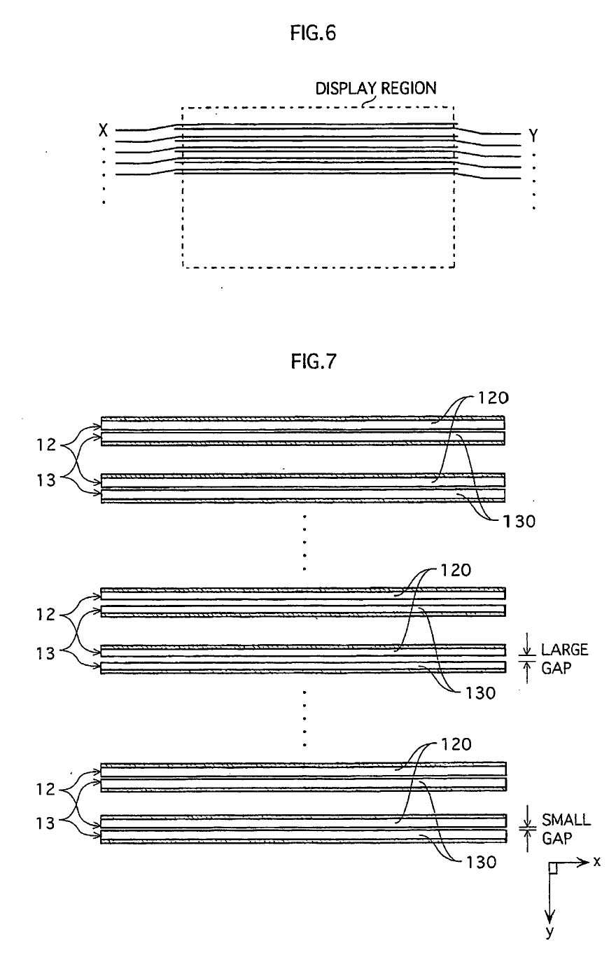

FIG. 6 shows an arrangement of the display electrodes 12 (X) and 13 (Y) within the display region of the PDP 1. FIG. 7 is a schematic view presenting the arrangement of the display electrodes 12 and 13 within the above display region in more detail.

As shown in FIG. 7, a second embodiment has the following characteristic. The display electrodes 12 and 13 that are arranged so as to be adjacent to each other in the vertical direction of the panel (the y direction) (strictly speaking, the transparent electrodes 120 and 130) gradually increase in width from the central region of the panel in the y direction towards the top and bottom edges of the panel.

The dimensions of various parts of the above PDP 1 are, for example, as follows.

The gap between one display electrode 12 and one display electrode 13 forming one pair: 80 μm to 100 μm

The width of one transparent electrode: 215 μm to 320 μm

The pitch Pₓ: 360 μm

The pitch P_{y}: 1080 μm

With this construction, in the cell group corresponding to narrow display electrodes 12 and 13 arranged in the panel central region, the gap G between the display electrodes 12 and 13 in each pair is large. Accordingly, the cell opening ratio is high, which ensures high luminance. On the other hand, in the cell group corresponding to wide display electrodes 12 and 13 arranged near the top and bottom edges of the panel, the cell opening ratio is low, which limits luminance to a low level. Here, the cell opening ratio indicates a percentage of a region that is not covered by the display electrodes, a light shielding material and the like, in a light-emitting region of the cell. In the above example, the ratio between the width of the display electrodes in the panel central region and that of the display electrodes in the panel peripheral region is preferably from 1:1.1 to 1:1.5. The ratio between the gap G between the display electrodes 12 and 13 in each pair in the panel central region and the gap Gin the panel peripheral region is preferably from 1:0.5 to 1:0.8. These ratios can be changed suitably.

Accordingly to the second embodiment, the average cell opening ratio is larger in the panel central region than in the panel peripheral region. As in the first embodiment, this contributes to higher luminance in the luminance in the panel central region, with it being possible to improve visibility.

The above part describes an example in which the width of the transparent electrodes is varied. However, similar effects are obtained by the following construction. The width of the transparent electrodes is fixed, and the gap between the display electrodes 12 and 13 in each pair is gradually decreased from the panel central region towards the top and bottom edges of the panel. This alternative construction has an advantage that the display electrodes can be easily formed because every display electrode on the entire panel has an identical shape.

[2.2. Modification of the Second Embodiment]

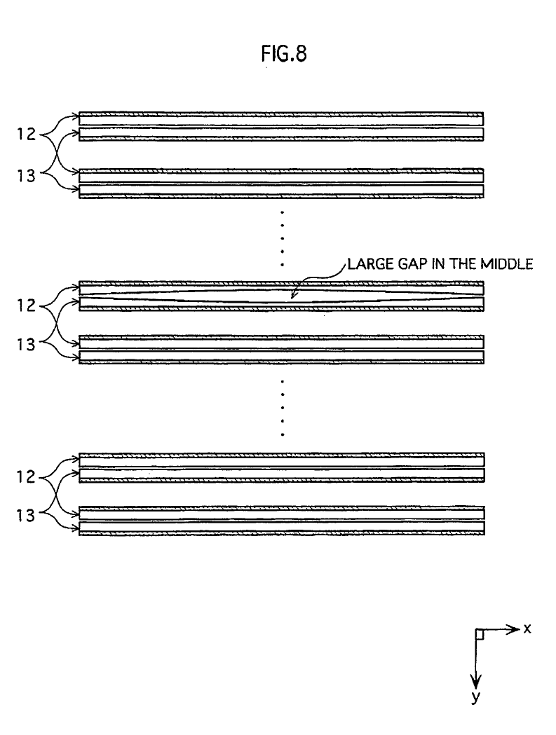

In the second embodiment described above with reference to FIG. 7, each of the transparent electrodes 120 and 130 included in the display electrodes 12 and 13 is strip electrodes. However, the invention is not limited to such. One example modification is a modification 2-1 shown in FIG. 8. In the modification 2-1, each of the transparent electrodes 120 and 130 of the display electrodes 12 and 13 arranged in the panel central region has a concave shape. More specifically, the lengthwise inner side of each of the transparent electrodes 120 and 130 is curved inwardly. The transparent electrodes 120 and 130 become less concaved and more strip-like towards the top and bottom edges of the panel. The largest and smallest widths of each of the transparent electrodes 120 and 130 having a concave shape are 320 μm and 215 μm respectively in this modification, though the invention is not limited to such.

When the display electrodes 12 and 13 include the transparent electrodes having a concave shape as in the above-described construction, the gap between the display electrodes 12 and 13 in each pair is comparatively large in the horizontal center areas of the display electrodes 12 and 13. In other words, the widths of the transparent electrodes 120 and 130 are small in the horizontal center areas of the display electrodes 12 and 13. This increases the cell opening ratio, thereby improving luminance. On the other hand, in the horizontal end areas of the display electrodes 12 and 13, the gap between the display electrodes 12 and 13 in each pair is comparatively small. In other words, the widths of the transparent electrodes 120 and 130 are large. This decreases the cell opening ratio, thereby limiting luminance to a low level. As a consequence, according to the present modification 2-1, the average cell opening ratio in the panel central region is increased even more effectively than in the second embodiment, realizing excellent display performance.

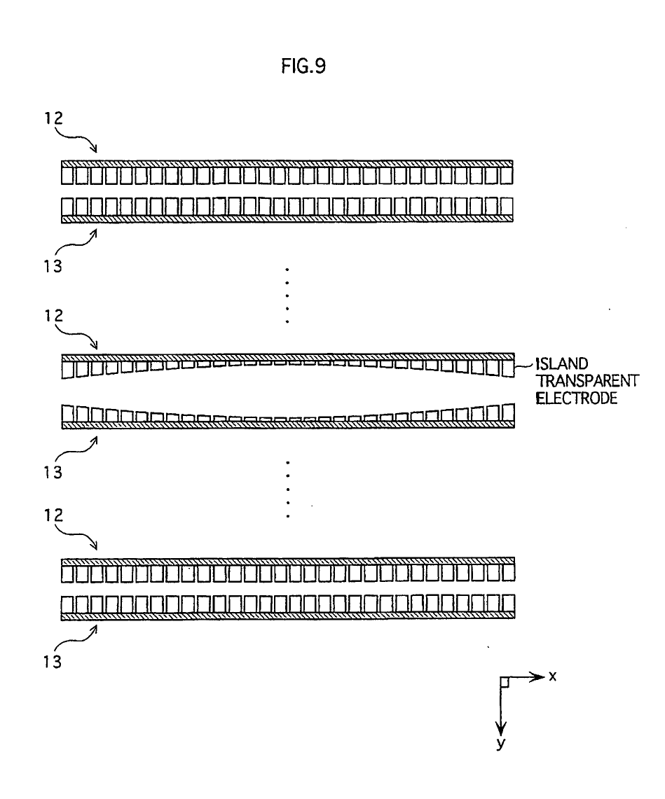

Here, each of the transparent electrodes 120 and 130 is one electrode extending in the lengthwise direction of the display electrodes 12 and 13, but not limited to such. Alternatively, each of the transparent electrodes 120 and 130 may be divided into a plurality of portions, and the portions maybe electrically connected to a corresponding bus line, namely, the bus line 121 or the bus line 131. This alternative configuration of the transparent electrodes 120 and 130 shown in FIG. 9 is based on the modification 2-1 shown in FIG. 8. FIG. 9 shows the transparent electrodes 120 and 130 which are each divided into a plurality of portions according to each cell, and each of the portions is separated from others. This construction is desirable for the following reason. For example, the barrier ribs 20 may be positioned in the spaces between the adjacent separated portions. This efficiently eliminates parts of the transparent electrodes 120 and 130 which do not contribute to light emission. As a result, power saving is improved.

In the present second embodiment and other embodiments, the width of the display electrodes 12 and 13, the width of the black matrixes (BM), or the width of the barrier ribs is made small in the panel central region. This is achieved by means of a photoetching method, which is mentioned in describing the manufacturing method of the PDP 1 relating to the first embodiment. As an alternative, this maybe achieved by a process of exposing a photosensitive material to light.

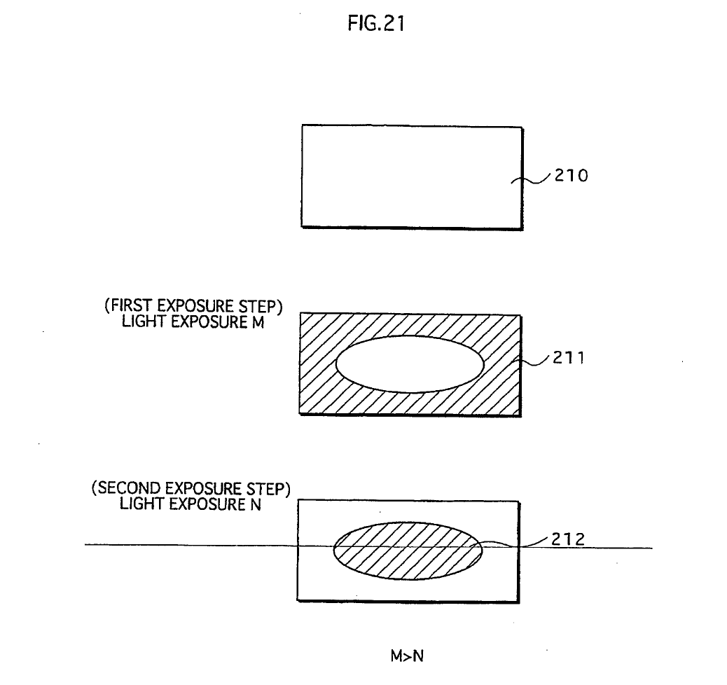

More specifically, a photosensitive material is applied onto the front panel glass 11, to obtain a panel 210 as shown in FIG. 21. A panel peripheral region 211 indicated by the shaded section is exposed to light in the first exposure step with an amount of light exposure M. Next, a panel central region 212 indicated by the encircled shaded section is exposed to light in the second exposure step with an amount of light exposure N. In this way, the exposure process is performed. The relation between M and N is M>N.

Light exposure is larger for the panel peripheral region 211 than for the panel central region 212 in the above-described method. In this way, the width of the display electrodes 12 and 13, the width of the black matrix (BM), or the width of the barrier ribs 20 is made larger in the panel peripheral region than in the panel central region. This enables the luminance in the panel central region to be increased.

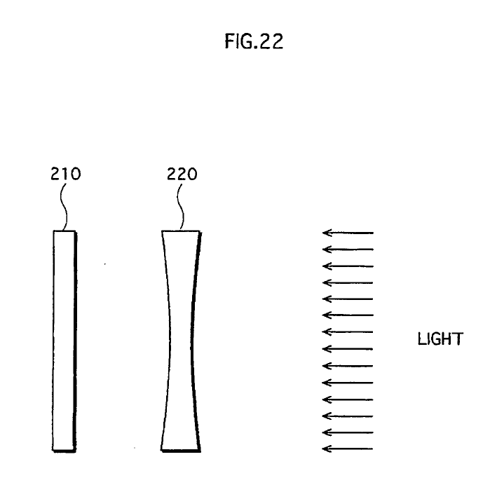

Alternatively, as shown in FIG. 22, the panel 210 obtained by applying a photosensitive material onto the front panel glass 11 may be exposed to light through a concave lens 220. This enables the panel central region and the panel peripheral region to be exposed to different amounts of light, producing the same result as the above method.

Third Embodiment

[3.1. Construction of the PDP]

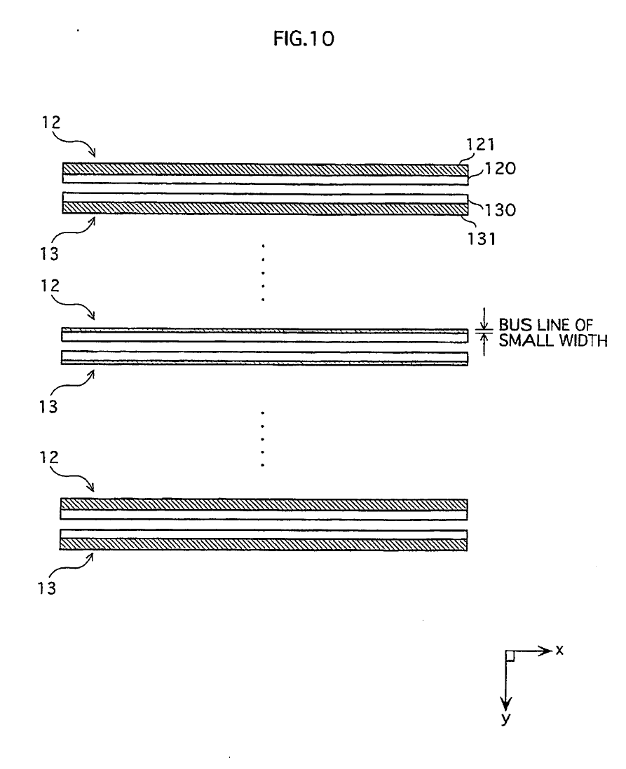

FIG. 10 is a schematic view showing, in detail, the arrangement of the display electrodes 12 and 13 in a third embodiment.

As shown in FIG. 10, the third embodiment has the following characteristic. The bus lines 121 and 131 gradually increase in width from the central region of the panel in the y direction towards the top and bottom edges of the panel. The bus lines 121 and 131 are included in the display electrodes 12 and 13 that are arranged so as to be adjacent to each other in the vertical direction of the panel (the y direction).

The dimensions of the various parts of the above PDP 1 are, for example, as follows.

The gap between one display electrode 12 and one display electrode 13 forming one pair: 90 μm

The width of the transparent electrode: 100 μm

The width of the bus line: 40 μm to 100 μm

The pitch Pₓ: 360 μm

The pitch P_{y}: 1080 μm

With this construction, in the panel central region where the widths of the bus lines 121 and 131 are small, the cell opening ratio is high, which ensures high luminance. On the other hand, in the top and bottom regions of the panel where the widths of the bus lines 121 and 131 are large, the cell opening ratio is low, which produces low luminance. According to the above-described example dimensions, the ratio between the width of the bus lines arranged in the panel central region and that of the bus lines near the top and bottom edges of the panel is preferably 1:1.6 to 1:2.5, but can be changed suitably. In this way, the average cell opening ratio is higher in the panel central region than in the panel peripheral region. Accordingly, low power consumption is attained and at the same time, relatively higher luminance is achieved in the panel central region, with it being possible to improve visibility, as in the above embodiments.

[3.2. Modification of the Third Embodiment]

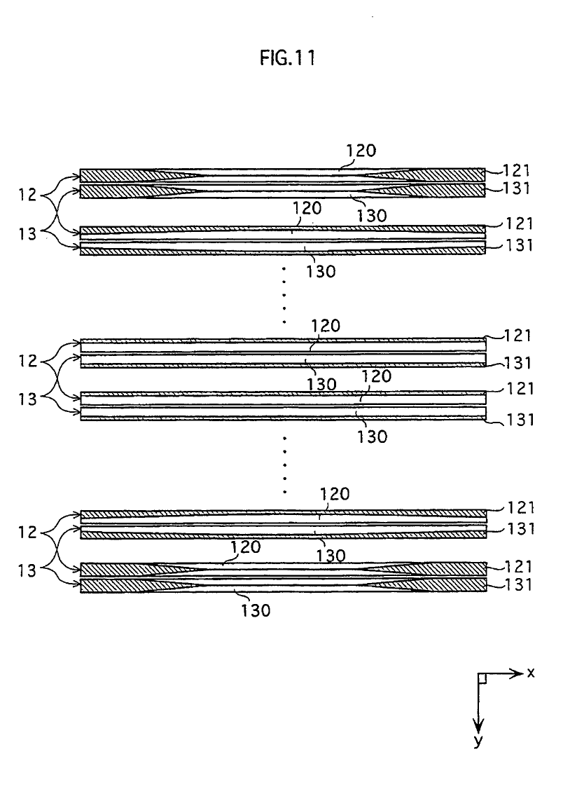

In the third embodiment described above with reference to FIG. 10, the bus lines are strip electrodes. However, the invention is not limited to such. For example, the transparent electrodes 120 and 130 that have a concave shape and are employed in the modification 2-1 may be applicable. Such modification is shown in FIG. 11 as a modification 3-1. In the modification 3-1, the bus lines 121 and 131 arranged in the panel central region are narrow. The widths of the bus lines 121 and 131 gradually change towards the top and bottom edges of the panel in such a manner that the shapes of the bus lines 121 and 131 gradually change into concave. Here, the lengthwise middle of the concave shape corresponds to the lengthwise middle of the bus lines 121 and 131.

This construction also enables the average cell opening ratio to be relatively higher in the panel central region than in the panel peripheral region, as in each of the above embodiments. Accordingly, low power consumption is attained, and at the same time, high luminance is achieved in the panel central region, with it being possible to realize excellent visibility.

Fourth Embodiment

[4.1. Construction of the PDP]

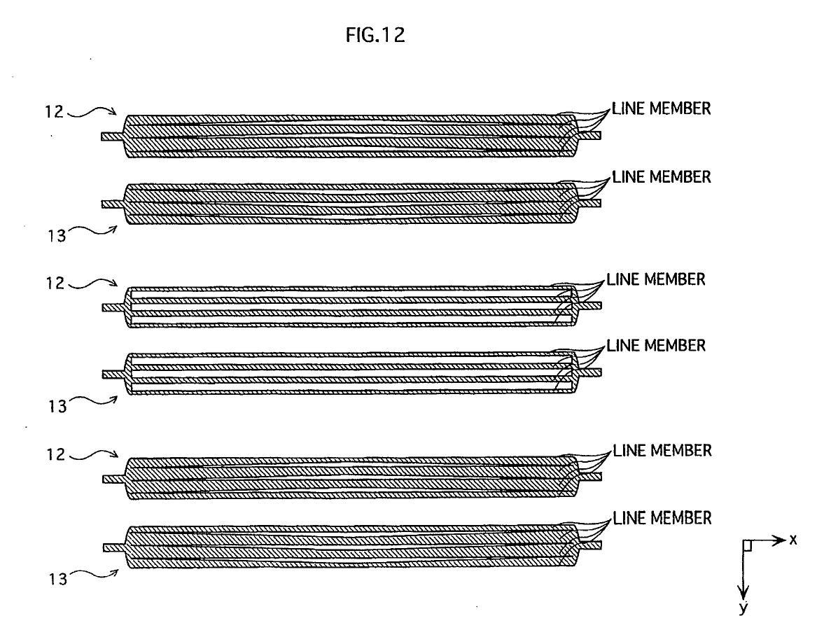

FIG. 12 is a schematic view showing, specifically, an arrangement of the display electrodes 12 and 13 in a fourth embodiment.

As shown in FIG. 12, the display electrodes 12 and 13 do not include the transparent electrodes 120 and 130 in the fourth embodiment. Instead, the display electrodes 12 and 13 are each formed as a fence (FE) electrode which is composed of a plurality of metal line members (four line members in the present fourth embodiment) extending in the x direction and electrically connected together at their ends in the x direction. These line members forming the display electrodes 12 and 13 are gradually changed into a concave shape from the central region of the panel in the y direction towards the top and bottom edges of the panel, to increase the electrode area from the panel central region towards the top and bottom edges of the panel.

The dimensions of the various parts of the above PDP 1 are, for example, as follows.

The gap between one display electrode 12 and one display electrode 13 forming one pair: 90 μm

The pitch Pₓ: 360 μm

The pitch P_{y}: 1080 μm

The width of one line member: 20 μm to 50 μm

Here, the address electrodes 18 used in the fourth embodiment have approximately the same dimensions as in the related art.

With this construction, in the panel central region where narrow line members are arranged, the cell opening ratio is high, which achieves high luminance. On the other hand, in the top and bottom regions of the panel where concave line members are arranged, the total width of concave line members included in each display electrode at their lengthwise ends is greater. This reduces the cell opening ratio, thereby limiting luminance to a low level. In this way, the average cell opening ratio is made higher in the panel central region than in the panel peripheral region, as in the above embodiments. As a result, low power consumption is attained, and at the same time, relatively higher luminance is achieved in the panel central region, with it being possible to increase visibility. The display electrodes 12 and 13 relating to the present fourth embodiment are formed as fence electrodes, which have low electrical resistance. This delivers excellent electrical characteristics and low power consumption.

It should be noted that the number of line members for each display electrode is not limited to four as shown in FIG. 12. However, it has to be taken into consideration that, if the number is too large, the patterning of the display electrodes becomes difficult and the cell opening ratio may decrease. Also, a connection part may be appropriately provided so as to electrically connect the plurality of line members in each of the display electrodes 12 and 13. This enables the electrical resistance of the display electrodes 12 and 13 to be further reduced. In addition, the cell opening ratio may be adjusted by gradually widening strip line members from the central region towards the top and bottom edges of the panel, instead of gradually concaving line members from the panel central region towards the top and bottom edges of the panel.

Fifth Embodiment

[5.1. Construction of the PDP]

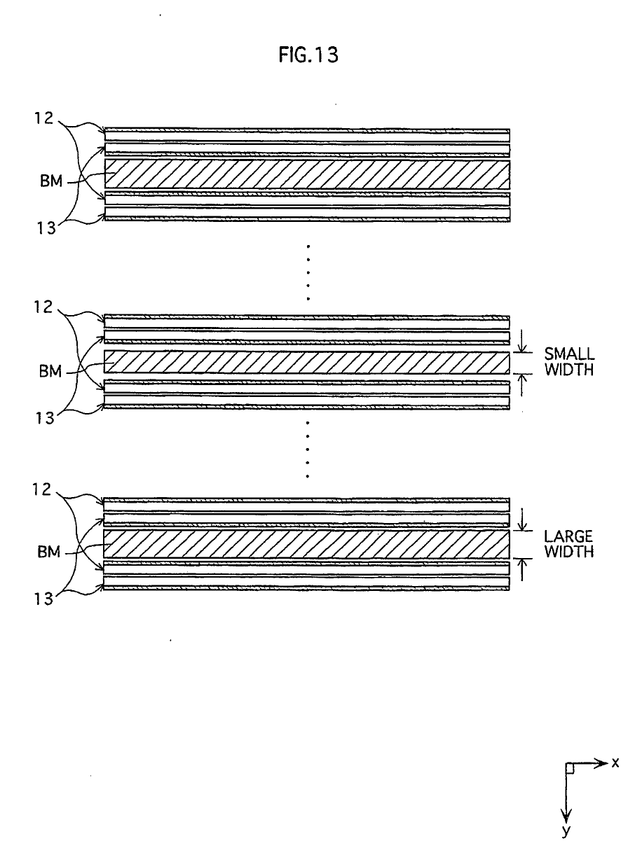

FIG. 13 is a schematic view showing, specifically, a construction around the display electrodes 12 and 13 in a fifth embodiment.

As shown in FIG. 13, the present fifth embodiment has a construction in which a black matrix (BM) composed of a black film is provided in the space between two adjacent pairs of display electrodes 12 and 13. The fifth embodiment is characterized in that the black matrixes gradually increase in width from the central region of the panel in the y direction towards the top and bottom edges of the panel.

The dimensions of the various parts of the above PDP 1 are, for example, as follows.

The gap between one display electrode 12 and one display electrode 13 forming one pair: 90 μm

The width of one transparent electrode: 150 μm

The width of one bus line: 40 μm

The pitch Pₓ: 360 μm

The pitch P_{y}: 1080 μm

The width of one black matrix: 150 μm to 300 μm

With this construction, in the panel central region with narrow black matrixes, the cell opening ratio is high. This ensures high luminance. On the other hand, in the top and bottom regions of the panel with wide black matrixes, the cell opening ratio is low. This is because the black matrixes prevent light from going through the front side of the discharge cells. Accordingly, luminance is limited to a low level. In this way, the average cell opening ratio is higher in the panel central region than in the panel peripheral region in the present fifth embodiment. As a consequence, low power consumption is attained, and at the same time, relatively higher luminance is achieved in the panel central region, with it being possible to improve visibility, as in each of the above embodiments.

[5.2. Modification of the Fifth Embodiment]

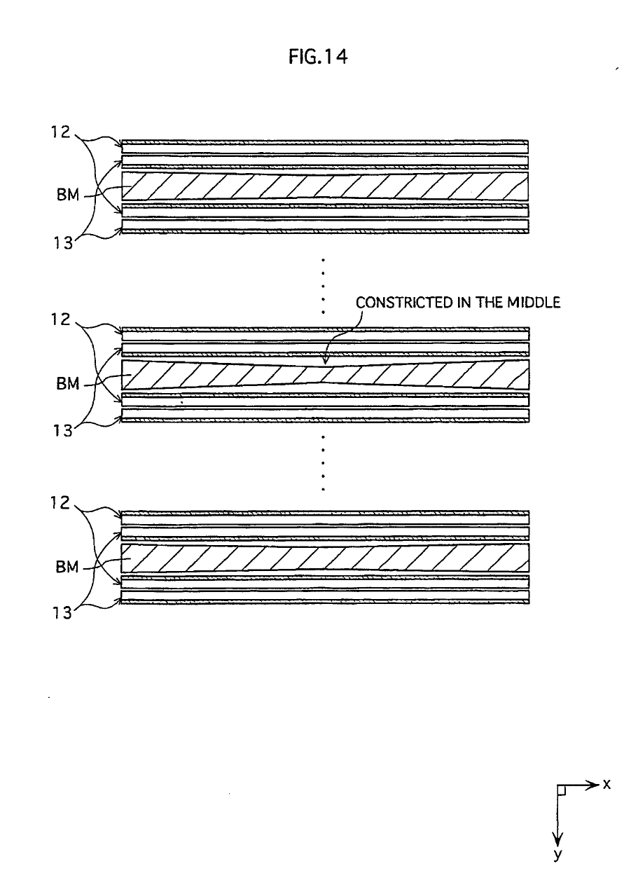

In the fifth embodiment shown in FIG. 13, the widths of the strip black matrixes are varied. However, the shape of the black matrixes is not limited to such. One example modification is a modification 5-1 shown in FIG. 14. In this modification, each black matrix is concaved. The concaves of the black matrixes are gradually made smaller from the panel central region towards the top and bottom edges of the panel, to increase the areas of the black matrixes from the panel central region towards the top and bottom edges of the panel. This construction enables the cell opening ratio in the panel central region to be further increased when compared with the ratio achieved by the construction shown in FIG. 13 in which strip black matrixes are arranged. As a result, the effects of the present invention are strengthened.

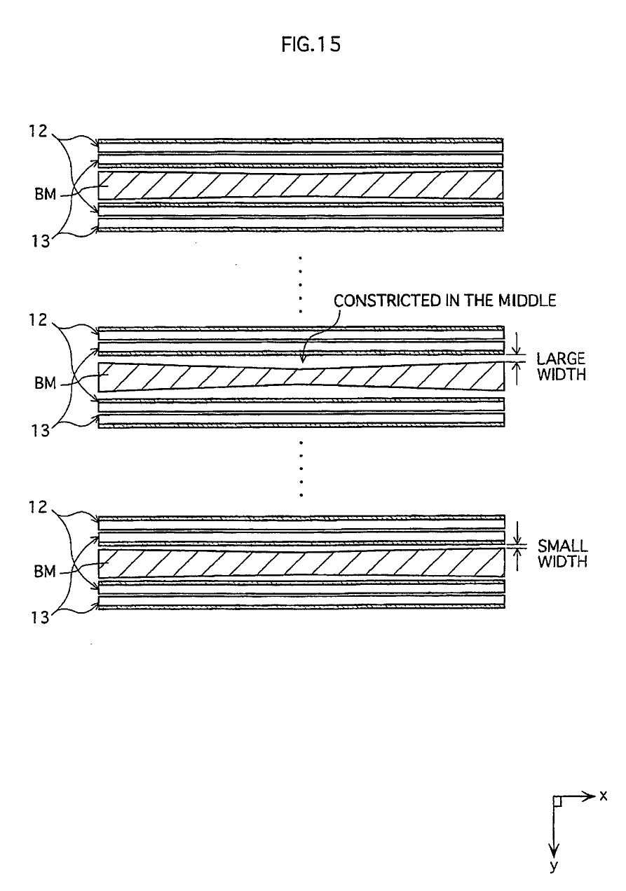

Moreover, in a modification 5-2 shown in FIG. 15, the black matrixes arranged in the panel central region are greatly concaved and besides, the width of their top and bottom ends is made smaller. With this construction, the areas of the black matrixes arranged in the panel central region are further reduced, heightening the effects of the present invention.

The black matrix pattern is not limited to those of FIG. 13 to FIG. 15. However, needless to say, it has to be remembered in designing PDPs that original effects of the black matrixes will be lost, if the areas of the black matrixes are reduced excessively.

Sixth Embodiment

[6.1. Construction of the PDP]

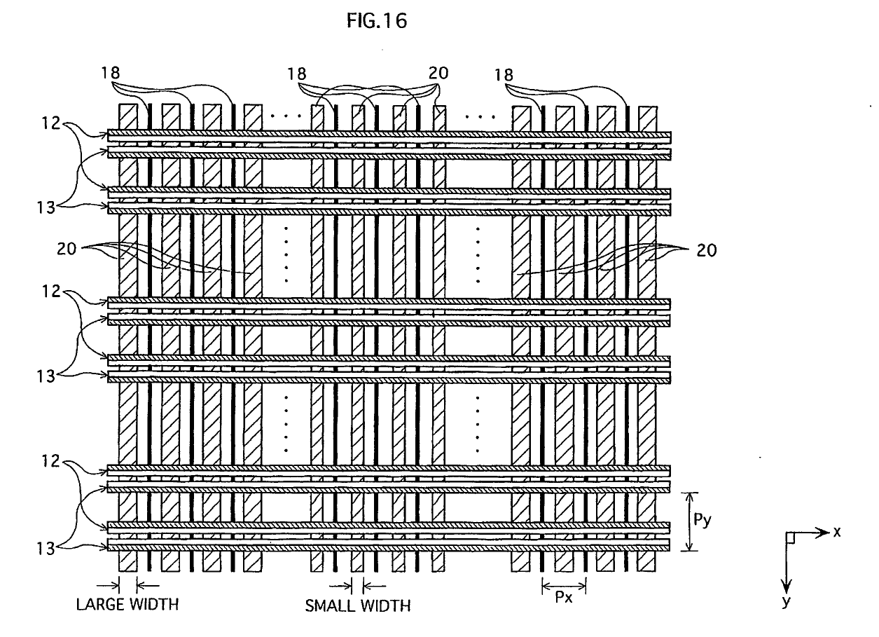

FIG. 16 is a schematic view showing an arrangement of the display electrodes 12 and 13, the address electrodes 18, and the barrier ribs 20 in the PDP 1.

As shown in FIG. 16, the sixth embodiment has the following characteristic. The barrier ribs 20 that are arranged so as to be adjacent to each other in the horizontal direction of the panel (the x direction) gradually increase in width from the panel central region towards the left and right edges of the panel.

The dimensions of the various parts of the above PDP 1 are, for example, as follows.

The gap between one display electrode 12 and one display electrode 13 forming one pair: 90 μm

The width of one transparent electrode: 150 μm

The pitch Pₓ: 360 μm

The pitch P_{y}: 1080 μm

The width of one barrier rib: 30 μm to 80 μm

Here, the display electrodes 12 and 13 and the address electrodes 18 used in the sixth embodiment have the same size as in the related art.

With this construction, in the panel central region where the widths of the barrier ribs 20 are small, the cell opening ratio is high. This achieves high luminance. On the other hand, in the left and right regions of the panel where the widths of the barrier ribs 20 are large, the cell opening ratio is low. This limits luminance to a low level. The sixth embodiment defines, as an example, that the ratio between the largest width and the smallest width of the barrier ribs 20 is 1:1.3 to 1:2. This enables the average cell opening ratio to be higher in the panel central region than in the panel peripheral region.

In addition, luminance is proportional to the area of the phosphor layers 21 to 23 facing the discharge spaces 24. When the barrier ribs 20 are narrower, areas to which phosphors are applied are wider, so that larger phosphor layers 21 to 23 are formed. Accordingly, in the PDP 1 relating to the sixth embodiment, a large amount of phosphors are applied in the cell group in the panel central region, to achieve high luminance. On the other hand, in the left and right regions of the panel where the barrier ribs 20 have a large width, the amount of phosphors applied is relatively small, which limits luminance to a low level. For the reasons stated above, low power consumption is attained, and at the same time, relatively higher luminance is achieved in the panel central region, with it being possible to improve visibility, as in the above embodiments.

[6.2. Modification of the Sixth Embodiment]

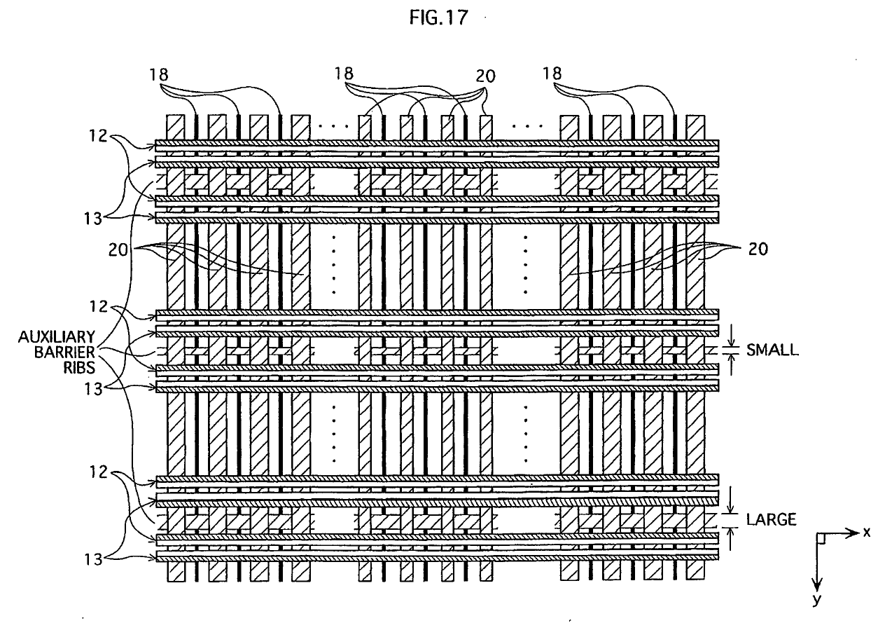

According to the sixth embodiment described above with reference to FIG. 16, the widths of the barrier ribs 20 are varied. However, the invention is not limited to such. One example modification is a modification 6-1 shown in FIG. 17. In FIG. 17, auxiliary barrier ribs are provided so as to alternate with the pairs of display electrodes 12 and 13. The auxiliary barrier ribs, as well as the barrier ribs 20, may increase in width from the panel central region towards the top and bottom edges of the panel.

The cells include the discharge spaces 24 which are surrounded by the barrier ribs 20 and the auxiliary barrier ribs arranged in double cross. This being so, the average cell opening ratio is higher in the panel central region than in the panel peripheral region. Accordingly, this construction enables relatively higher luminance to be achieved in the panel central region.

Here, according to the example of the modification 6-1, the widths of the barrier ribs 20 and those of the auxiliary barrier ribs are adjusted. The present invention is, however, not limited to such, and widths of either the barrier ribs or auxiliary barrier ribs only may be adjusted.

Seventh Embodiment

[7.1. Construction of the PDP]

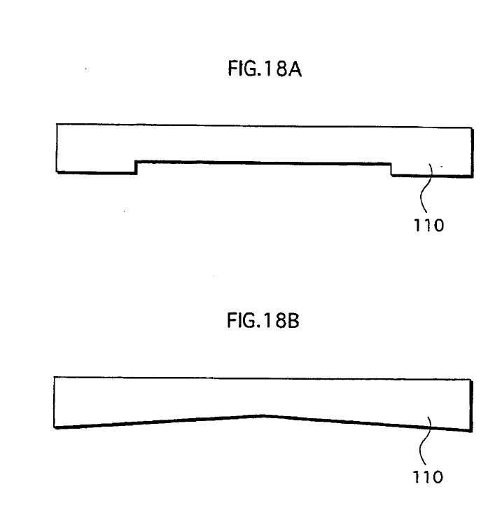

FIG. 18A and FIG. 18B are schematic views showing a cross section of the dielectric layer 14 in the PDP 1 relating to a seventh embodiment taken along the y direction.

As shown in FIGS. 18A and 18B, the thickness of the dielectric layer 14 is smaller in the panel central region than in the panel peripheral region in the seventh embodiment. Here, the thickness is reduced from the surface closer to the discharge spaces 24. (The panel central region and panel peripheral region are defined in the first embodiment.) The dielectric layer 14, as an example, is 20 μm and 50 μm in thickness in the panel central region and in the panel peripheral region respectively with a thickness ratio of 1:2 to 1:2.5. The thicknesses and the thickness ratio can be suitably changed. FIG. 18A shows a dielectric layer 14 whose thickness changes suddenly between the panel central region and the panel peripheral region. FIG. 18B shows a dielectric layer 14 whose thickness gradually changes as the surface of the dielectric layer 14 inclines from the panel central region towards the panel peripheral region.

With these constructions, in the panel central region with thin dielectric layer 14, transmittance efficiency of the visible light generated inside the discharge spaces 24 is high. This achieves high luminance. On the other hand, in the panel peripheral region with thick dielectric layer 14, the visible light transmittance efficiency is lower than in the panel central region. Accordingly, with the configurations of the dielectric layer 14 relating to the seventh embodiment, the average visible light transmittance efficiency is higher in the panel central region than in the panel peripheral region. This achieves low power consumption and at the same time, achieves higher luminance in the panel central region in which image information tends to concentrate, with it being possible to improve visibility.

The thickness of the dielectric layer shown in FIG. 18A changes at the border between the panel central region and the panel peripheral region. This construction strengthens the effects of improving visibility in the panel central region. Moreover, as an alternative to the construction shown in FIG. 18A, the thickness of the dielectric layer 14 may be changed in more than one step. Such a construction has the following advantage. The dielectric layer 14 having the above construction is comparatively easily formed by overlaying dielectric sheets (described later) whose middle portions are clipped off. On the other hand, the thickness of the dielectric layer 14 shown in FIG. 18B gradually increases from the panel central region to the panel peripheral region. Here, the gradient angle of the surface of the dielectric layer 14 (from the panel central region towards the panel peripheral region) is preferably in a range from 0.007° to 0.002° in the case of PDPs in 42-inch range.

Alternatively, a dielectric layer of a semicircular arch in cross section may be used instead of the dielectric layers having the above constructions. The top of such a semicircular arch corresponds to the panel central region. The dielectric layer 14 of such cross-sectional configuration is desirable for the following reason. Such dielectric layer can produce a lens effect to some extent, and the cell opening ratio in the panel central region efficiently increases.

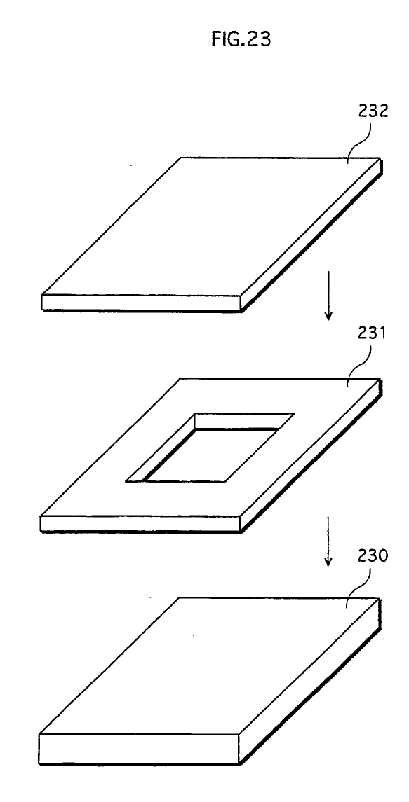

The dielectric layer 14 having the above configuration may be formed in the following manner. A dielectric sheet whose thickness is adjusted beforehand is prepared for the manufacturing process. The dielectric sheet is attached to the surface of the front panel glass 11 on which the display electrodes 12 and 13 are formed, and the result is fired. One example of this forming method is shown in FIG. 23. A dielectric sheet 231 with an opening in the middle and a flat dielectric sheet 232 are laminated on a front panel glass 230 on which the display electrodes 12 and 13 are formed.

The method of attaching dielectric sheets is not limited to the above. For example, the dielectric sheet 231 with an opening in the middle and the flat dielectric sheet 232 may be attached in a reversed order. Furthermore, dielectric sheets which have two or more different configuration are laminated together in advance and then attached in one operation.

Other Modifications

In the embodiments described above, the size or the shape of some of the structural components is changed (gradually increased or decreased) from the panel central region towards the top and bottom or the left and right edges of the panel. Those structural components include the display electrodes 12 and 13, the black matrixes, the barrier ribs 20, and the auxiliary barrier ribs. However, the present invention is not limited to such. The size or the shape may be varied step wise, for example, every several pairs or several dozen pairs of the display electrodes, or every several or several dozen black matrixes, barrier ribs 20 or auxiliary barrier ribs. In this case, the cell opening ratio, the cell area, or the visible light transmittance efficiency is locally different, and this should not affect visibility when displaying an image.

As described in the above embodiments, the display electrodes 12 and 13 of a desired pattern can be formed using an exposure mask 181 shown in FIG. 19 or FIG. 20. The exposure mask 181 has openings 180 that are adjusted for forming the pattern of the display electrodes 12 and 13. This is utilized in the following manner. First of all, a photosensitive material (e.g. ultraviolet-cure resin) is applied on to the entire surface of the front panel glass 11 in a thickness of 0.5 μm. Next, the photosensitive material is covered with the exposure mask 181 having the openings 180 to form a desired electrode pattern, and irradiated with ultraviolet rays. After this, the result is soaked in a developer so as to wash off uncured resin. In this way, gaps in the photosensitive material are formed on the surface of the front panel glass 11. These gaps are filled with an Ag paste or an ITO material, and the result is fired to obtain the display electrodes 12 and 13 of the desired electrode pattern.

### INDUSTRIAL APPLICABILITY

The present invention is applicable to a gas discharge panel including a PDP used as a display screen on televisions and computers.

1. A plasma display panel including a first panel member in which a plurality of pairs of display electrodes are arranged so as to be adjacent to each other in a column direction and a second panel member in which a plurality of address electrodes are arranged so as to be adjacent to each other in a row direction, the first panel member and the second panel member being opposed to each other so that a plurality of cells are formed in a matrix in areas where the plurality of pairs of display electrodes intersect with the plurality of address electrodes, characterized in that
at least one of an average cell area, an average cell opening ratio and an average visible light transmittance efficiency is greater in a panel central region than in a panel peripheral region.

2. The plasma display panel of claim 1, wherein
a distance between adjacent pairs of display electrodes is larger in a central region than in both edge regions of the panel in the column direction.

3. The plasma display panel of claim 1, wherein
a distance between adjacent address electrodes is larger in a central region than in both edge regions of the panel in the row direction.

4. The plasma display panel of claim 1, wherein
a distance between adjacent pairs of display electrodes is larger in a central region than in both edge regions of the panel in the column direction, and
a distance between adjacent address electrodes is larger in a central region than in both edge regions of the panel in the row direction.

5. The plasma display panel of claim 1, wherein
a gap between electrodes in a pair of display electrodes in a central region of the panel in the column direction is larger than a gap between electrodes in a pair of display electrodes in each edge region of the panel in the column direction.

6. The plasma display panel of claim 5, wherein
in a pair of display electrodes, a gap between electrodes decreases from a center towards both ends of the pair of display electrodes in a lengthwise direction.

7. The plasma display panel of claim 1, wherein
each display electrode is formed by laminating a bus line on a transparent electrode, and
a bus line in a central region of the panel in the column direction is wider than a bus line in each edge region of the panel in the column direction.

8. The plasma display panel of claim 7, wherein
a bus line of a display electrode decreases in width from a center towards both ends of the display electrode in a lengthwise direction.

9. The plasma display panel of claim 1, wherein
each display electrode is composed of a set of metal line members that are electrically connected together, and
a width of a set of metal line members in a central region of the panel in the column direction is smaller than a width of a set of metal line members in each edge region of the panel in the column direction.

10. The plasma display panel of claim 9, wherein
a set of metal line members of a display electrode increases in width from a center towards both ends of the display electrode in a lengthwise direction.

11. The plasma display panel of claim 1, wherein
black films are formed on the first panel member between adjacent pairs of display electrodes, and
black films in a central region of the panel in the column direction are narrower than black films in each edge region of the panel in the column direction.

12. The plasma display panel of claim 11, wherein
a black film increases in width from a center towards both ends of the black film in a lengthwise direction.

13. The plasma display panel of claim 1, wherein
barrier ribs are disposed between the first panel member and the second panel member so as to alternate with the plurality of address electrodes, and
barrier ribs in a central region of the panel in the row direction are narrower than barrier ribs in each edge regions of the panel in the row direction.

14. The plasma display panel of claim 1, wherein
auxiliary barrier ribs are formed between the first panel member and the second panel member so as to alternate with the plurality of pairs of display electrodes, and
auxiliary barrier ribs in a central region of the panel in the column direction are narrower than auxiliary barrier ribs in each edge regions of the panel in the column direction.

15. The plasma display panel of claim 1, wherein
a dielectric layer is formed on the first panel member so as to cover the plurality of pairs of display electrodes, and
a thickness of the dielectric layer is greater in the panel central region than in the panel peripheral region.

16. An exposure mask for forming at least one of a display electrode, a barrier rib, and a black film on a surface of a panel member using a photoetching method in a manufacturing process of a plasma display panel, characterized in that
an average opening ratio is higher in a portion of the exposure mask corresponding to a panel central region than in a portion of the exposure mask corresponding to a panel peripheral region.

17. A dielectric sheet for forming a dielectric layer on a surface of a panel member on which a display electrode has been arranged in a manufacturing process of a plasma display panel, characterized in that
a portion of the dielectric sheet corresponding to a panel central region has a larger thickness than a portion of the dielectric sheet corresponding to a panel peripheral region.

18. A plasma display panel manufacturing method including a display electrode forming step of forming a plurality of display electrodes on a surface of a first panel member and a barrier rib forming step of forming a plurality of barrier ribs on a surface of a second panel member, characterized in that
in at least one of the display electrode forming step and the barrier rib forming step, a photosensitive material is applied onto a surface of a corresponding one of the first and second panel members so as to perform a patterning operation by exposing the photosensitive material to light through an exposure mask, and
during the patterning operation, light exposure to the photosensitive material is locally varied so as to set widths of the plurality of display electrodes or the plurality of barrier ribs.

19. The plasma display panel manufacturing method of claim 18, wherein
the photosensitive material is a resist material used for etching.
